(19) United States
(12) Patent Application Publication
(10) Pub. No.: US 2013/0297314 A1
(43) Pub. Date: Nov. 7, 2013

(54) RESCORING METHOD AND APPARATUS IN DISTRIBUTED ENVIRONMENT

(71) Applicant: ELECTRONICS AND TELECOMMUNICATIONS, Daejeon-city (KR)

(72) Inventors: Eui-Sok CHUNG, Daejeon (KR); Hyung-Bae Jeon, Daejeon (KR); Hwa-Jeon Song, Daejeon (KR); Yun-Keun Lee, Daejeon (KR)

(73) Assignee: ELECTRONICS AND TELECOMMUNICATIONS RESEARCH INSTITUTE, Daejeon-city (KR)

(21) Appl. No.: 13/655,961

(22) Filed: Oct. 19, 2012

(30) Foreign Application Priority Data
May 7, 2012 (KR) 10-2012-0048027

(51) Int. Cl. G10L 15/18

(52) U.S. Cl. 704/257; 704/E15.018

(57) ABSTRACT

Disclosed are a distributed environment rescoring method and apparatus. A distributed environment rescoring method in accordance with the present invention includes generating a word lattice by performing voice recognition on received voice, converting the word lattice into a word confusion network formed from the temporal connection of confusion sets clustered based on temporal redundancy and phoneme similarities, generating a list of subword confusion networks based on the entropy values of the respective confusion sets included in the word confusion network, and generating a modified word confusion network by modifying a list of the subword confusion networks through distributed environment rescoring.

### CROSS-REFERENCE(S) TO RELATED APPLICATION(S)

This application claims priority to Korean Patent Application No. 10-2012-0048027 filed on May 7, 2012 which is incorporated herein by reference in its entirety.

### BACKGROUND OF THE INVENTION

1. Field of the Invention

Exemplary embodiments of the present invention relate to voice recognition, and particularly to a distributed environment rescoring method and apparatus based on confusion networks.

2. Description of Related Art

Voice recognition technology may mean technology that supports people so that they are provided with control or information services relating to desired terminals that are used in daily life using voice, that is, the most friendly and convenient communication tool, without using the mouse or the keyboard.

Furthermore, voice recognition technology may be applied to an intelligent robot, telematics, a home network, the next-generation PC, and digital content search.

Meanwhile, in the current, rapidly developing, and ubiquitous information technology environment, there is an urgent need for voice recognition technology because the size of an information device is reduced and mobility has become important.

U.S. Patent Application Publication No. 2009/0248416, that is, technology related to voice recognition, may be utilized in a spoken language understanding module for a dial log system using confusion networks. The U.S. patent application Publication discloses technology for converting a word lattice into a confusion network, performing preprocessing on the confusion network, and determining a class type by matching the confusion network with a spoken language understanding grammar, but it is problematic in that a lot of network traffic occurs.

Accordingly, the present invention proposes a rescoring method and apparatus in a distributed environment, which can minimize network traffic in a distributed network environment.

### SUMMARY OF THE INVENTION

An embodiment of the present invention is directed to a distributed environment rescoring method which can minimize network traffic in a distributed environment.

Another embodiment of the present invention is directed to a distributed environment rescoring apparatus which can minimize network traffic in a distributed environment.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a distributed environment rescoring method in accordance with the present invention includes generating a word lattice by performing voice recognition on received voice, converting the word lattice into a word confusion network formed from the temporal connection of confusion sets clustered based on temporal redundancy and phoneme similarities, generating a list of subword confusion networks based on the entropy values of the respective confusion sets included in the word confusion network, and generating a modified word confusion network by modifying a list of the subword confusion networks through distributed environment rescoring.

Here, the word lattice may be a graph that indicates the connection and directivity of word candidates recognized through the voice recognition.

Here, the confusion set may comprise a list of words recognized through the voice recognition, and each of the recognized words may have a posterior probability value.

Generating a list of subword confusion networks based on entropy values of the respective confusion sets included in the word confusion network may comprise calculating the entropy value based on posterior probability values of words included in the confusion set and selecting the confusion set as a candidate of the subword confusion network based on the entropy value, and generating a list of the subword confusion networks based on context of the words included in the confusion set selected as the candidate of the subword confusion network.

Generating a modified word confusion network by modifying a list of the subword confusion networks through distributed environment rescoring may comprise generating a list of distributed queries (openquery) to be transmitted to a plurality of distributed servers distributed over a network environment based on a list of the subword confusion networks, generating a distributed query set capable of being processed by the plurality of distributed servers based on a list of the distributed queries, transmitting the distributed query set to the plurality of distributed servers and receiving a score value for the distributed query set from each of the plurality of distributed servers, and rescoring a list of the subword confusion networks based on the score value for the distributed query set and generating the modified word confusion network by integrating a list of the rescored subword confusion networks and the word confusion network.

Here, a list of the distributed queries may be an n-gram list, and the distributed query set may be classified into the n-gram list.

In accordance with another embodiment of the present invention, a distributed environment rescoring apparatus comprises a voice recognition unit configured to generate a word lattice by performing voice recognition on received voice, a word confusion network generation unit configured to convert the word lattice into a word confusion network that is formed from the temporal connection of confusion sets clustered based on temporal redundancy and phoneme similarities, a subword confusion network list generation unit configured to generate a list of subword confusion networks based on the entropy values of the respective confusion sets included in the word confusion network, and a distributed environment rescoring unit configured to generate a modified word confusion network by modifying a list of the subword confusion networks through distributed environment rescoring.

Here, the word lattice may be a graph that indicates the connection and directivity of word candidates recognized through the voice recognition.

Here, the confusion set may comprise a list of words recognized through the voice recognition, and each of the recognized words may have a posterior probability value.

The subword confusion network list generation unit may calculate the entropy value based on the posterior probability values of words included in the confusion set, select the confusion set as a candidate of the subword confusion network based on the entropy value, and generate a list of the subword confusion networks based on context of the words included in the confusion set selected as the candidate of the subword confusion network.

The distributed environment rescoring unit may generate a list of distributed queries (openquery) to be transmitted to a plurality of distributed servers distributed over a network environment based on a list of the subword confusion networks, generate a distributed query set capable of being processed by the plurality of distributed servers based on a list of the distributed queries, transmit the distributed query set to the plurality of distributed servers, receive a score value for the distributed query set from each of the plurality of distributed servers, rescore a list of the subword confusion networks based on the score value for the distributed query set, and generate the modified word confusion network by integrating a list of the rescored subword confusion networks and the word confusion network.

Here, a list of the distributed queries may be an n-gram list, and the distributed query set may be classified into the n-gram list.

### BRIEF DESCRIPTION OF THE DRAWINGS

FIG. 1 is a flowchart illustrating a distributed environment rescoring method in accordance with one embodiment of the present invention.

FIG. 2 is a flowchart illustrating a method of generating a list of subword confusion networks in the distributed environment rescoring method of FIG. 1.

FIG. 3 is a flowchart illustrating a method of generating a list of modified word confusion networks in the distributed environment rescoring method of FIG. 1.

FIG. 4 is a block diagram showing a distributed environment rescoring apparatus in accordance with one embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

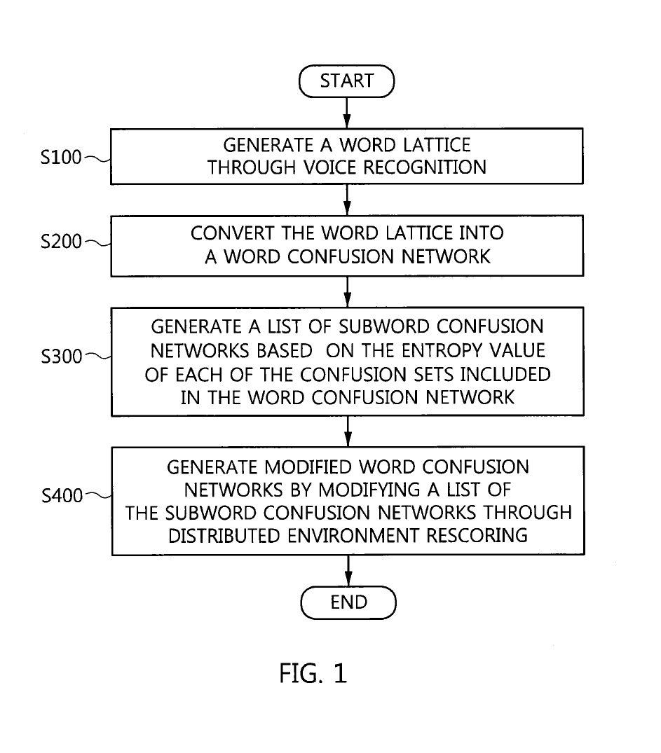

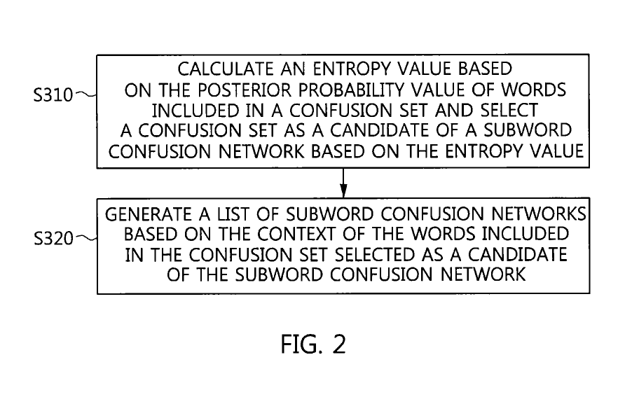

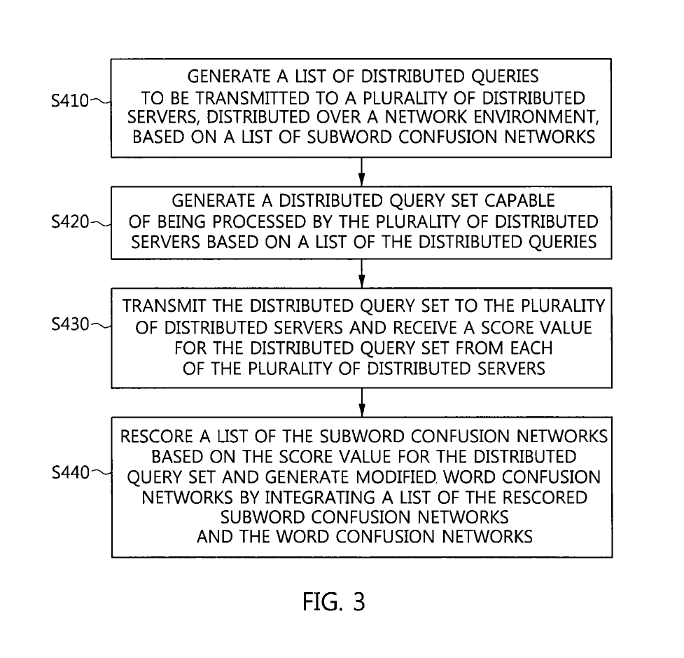

FIG. 1 is a flowchart illustrating a distributed environment rescoring method in accordance with one embodiment of the present invention, FIG. 2 is a flowchart illustrating a method of generating a list of subword confusion networks in the distributed environment rescoring method of FIG. 1, and FIG. 3 is a flowchart illustrating a method of generating a list of modified word confusion networks in the distributed environment rescoring method of FIG. 1.

Referring to FIGS. 1 to 3, the distributed environment rescoring method can include generating a word lattice by performing voice recognition on received voice at step S100 and converting the word lattice into a word confusion network formed from the temporal connection of confusion sets that are clustered based on temporal redundancy and phoneme similarities at step S200.

Particularly, the word lattice generated by performing voice recognition on the received voice can mean a graph that indicates the connection and directivity of word candidates recognized through the voice recognition.

Each of the confusion sets includes a list of words recognized through voice recognition, and each of the recognized words can have a posterior probability value.

Next, a list of subword confusion networks can be generated based on the entropy values of the respective confusion sets included in the word confusion network at step S300.

Particularly, at step S300, the entropy value can be calculated based on the posterior probability values of words included in the confusion set and the confusion set can be selected as a candidate of a subword confusion network based on the entropy value at step S310, and a list of the subword confusion networks can be generated based on the context of the words included in the confusion set selected as a candidate of the subword confusion network at step S320.

Particularly, the entropy value of each confusion set can be calculated based on the posterior probability values of words included in each confusion set, the entropy values of the respective confusion sets can be compared with each other, and a confusion set having an entropy value higher than a predetermined reference can be selected as a candidate of a subword confusion network based on a result of the comparison. Furthermore, the confusion set selected as a candidate of the subword confusion network can be extended to a list of subword confusion networks according to the context of words included in the confusion set.

Meanwhile, the posterior probability values of the words included in the confusion set may be values averaged within the confusion set.

Next, a modified word confusion network can be generated by modifying a list of the subword confusion networks through distributed environment rescoring at step S400.

Particularly, at step S400, a list of distributed queries (openquery) to be transmitted to a plurality of distributed servers distributed over a network environment can be generated based on a list of the subword confusion networks at step S410, a distributed query set capable of being processed by the plurality of distributed servers can be generated based on a list of the distributed queries at step S420, the distributed query set can be transmitted to the plurality of distributed servers and a score value for the distributed query set can be received from each of the plurality of distributed servers at step S430, and a list of the subword confusion networks can be rescored based on the score value for the distributed query set and the modified word confusion network can be generated by integrating a list of the rescored subword confusion networks and the word confusion network at step S440.

For example, an n-gram list can become the distributed query list. In this case, the distributed query set can mean a set classified into the n-gram list capable of being processed by a distributed server or a set of the distributed servers. The distributed query set can be classified using a variety of methods, such as order of alphabet and using a hash function.

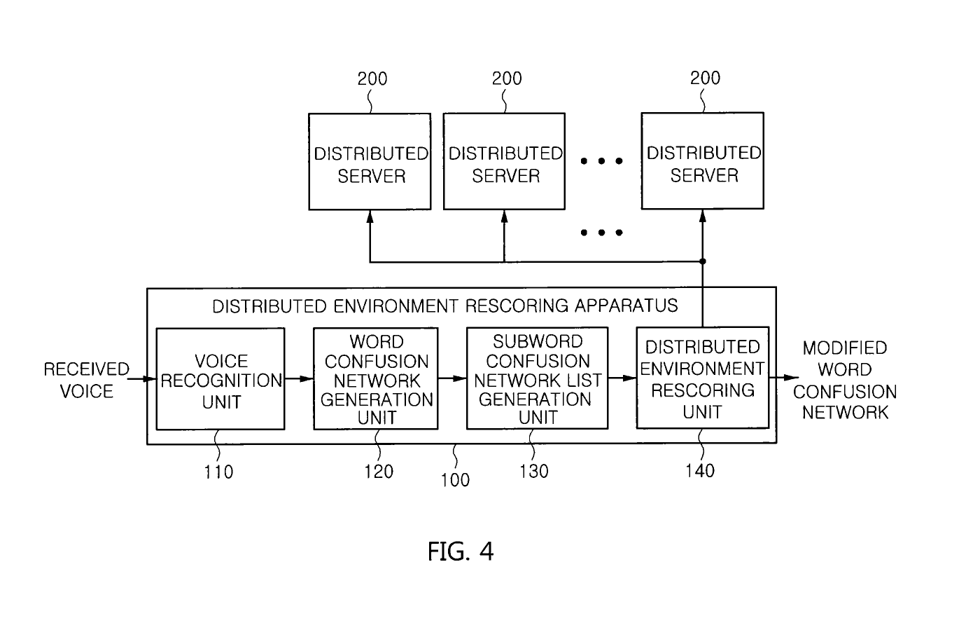

FIG. 4 is a block diagram showing a distributed environment rescoring apparatus in accordance with one embodiment of the present invention.

Referring to FIG. 4, the distributed environment rescoring apparatus 100 can include a voice recognition unit 110, a word confusion network generation unit 120, a subword confusion network list generation unit 130, and a distributed environment rescoring unit 140.

The voice recognition unit 110 can generate a word lattice by performing voice recognition on received voice. The word lattice can mean a graph that displays the connection and directivity of word candidates recognized through voice recognition.

The word confusion network generation unit 120 can convert the word lattice into a word confusion network that is formed from the temporal connection of confusion sets clustered based on temporal redundancy and phoneme similarities. Here, each of the confusion sets includes a list of words recognized through voice recognition, and each of the recognized words can have a posterior probability value.

The subword confusion network list generation unit 130 can generate a list of subword confusion networks based on the entropy values of the confusion sets included in the word confusion network.

The subword confusion network list generation unit 130 can calculate an entropy value based on the posterior probability values of the words included in the confusion set, select the confusion set as a candidate of a subword confusion network based on the entropy value, and generate a list of the subword confusion networks based on the context of the words included in the confusion set that has been selected as a candidate of the subword confusion network.

Particularly, the entropy value of each of the confusion sets can be calculated based on the posterior probability values of words included in each confusion set, the entropy values of the respective confusion sets can be compared with each other, and a confusion set having an entropy value higher than a predetermined reference can be selected as a candidate of a subword confusion network based on a result of the comparison. Furthermore, the confusion set selected as a candidate of the subword confusion network can be extended to a list of subword confusion networks according to the context of the words that form the confusion set.

Meanwhile, the posterior probability values of the words included in the confusion set may be values averaged within the confusion set.

The distributed environment rescoring unit 140 can generate a modified word confusion network by modifying a list of the subword confusion networks through distributed environment rescoring.

Particularly, the distributed environment rescoring unit 140 can generate a list of distributed queries (openquery) to be transmitted to a plurality of distributed servers distributed over a network environment based on a list of the subword confusion networks, generate a distributed query set capable of being processed by the plurality of distributed servers based on a list of the distributed queries, transmit the distributed query set to the plurality of distributed servers, receive a score value for the distributed query set from each of the plurality of distributed servers, rescore a list of the subword confusion networks based on the score value for the distributed query set, and generate the modified word confusion network by integrating a list of the rescored subword confusion networks and the word confusion network.

For example, an n-gram list can become the distributed query list. In this case, the distributed query set can mean a set classified into the n-gram list capable of being processed by a distributed server or a set of the distributed servers. The distributed query set can be classified using a variety of methods, such as alphabetical order and using a hash function.

As described above, the distributed environment rescoring method and apparatus in accordance with the present invention are not limited to the construction and method of the above-described embodiments, but may be constructed by a selective combination of some of or all the embodiments so that the embodiments are modified in various ways.

In accordance with the present invention, in performing voice recognition in a distributed environment, a word lattice generated by performing voice recognition on received voice is converted into a word confusion network formed from the temporal connection of confusion sets that are clustered based on temporal redundancy and phoneme similarities. A list of subword confusion networks is generated based on the entropy values of the respective confusion sets. Modified word confusion networks are generated through distributed environment rescoring. Accordingly, distributed environment rescoring can be optimized.

Furthermore, network traffic can be minimized by optimizing distributed environment rescoring.

While the present invention has been described with respect to the specific embodiments, it will be apparent to those skilled in the art that various changes and modifications may be made without departing from the spirit and scope of the invention as defined in the following claims.

What is claimed is:

1. A distributed environment rescoring method, comprising:
generating a word lattice by performing voice recognition on received voice;
converting the word lattice into a word confusion network formed from temporal connection of confusion sets clustered based on temporal redundancy and phoneme similarities;
generating a list of subword confusion networks based on entropy values of the respective confusion sets included in the word confusion network; and
generating a modified word confusion network by modifying the list of the subword confusion networks through distributed environment rescoring.

2. The distributed environment rescoring method of claim 1, wherein the word lattice is a graph that indicates a connection and directivity of word candidates recognized through the voice recognition.

3. The distributed environment rescoring method of claim 1, wherein:
the confusion set comprises a list of words recognized through the voice recognition, and
each of the recognized words has a posterior probability value.

4. The distributed environment rescoring method of claim 1, wherein generating the list of subword confusion networks based on entropy values of the respective confusion sets included in the word confusion network comprises:
calculating the entropy value based on posterior probability values of words included in the confusion set and selecting the confusion set as a candidate of the subword confusion network based on the entropy value; and
generating the list of the subword confusion networks based on context of the words included in the confusion set selected as the candidate of the subword confusion network.

5. The distributed environment rescoring method of claim 4, wherein generating a modified word confusion network by modifying the list of the subword confusion networks through distributed environment rescoring comprises:
generating a list of distributed queries (openquery) to be transmitted to a plurality of distributed servers distributed over a network environment based on the list of the subword confusion networks;
generating a distributed query set capable of being processed by the plurality of distributed servers based on the list of the distributed queries;
transmitting the distributed query set to the plurality of distributed servers and receiving a score value for the distributed query set from each of the plurality of distributed servers; and
rescoring the list of the subword confusion networks based on the score value for the distributed query set and generating the modified word confusion network by integrating the list of the rescored subword confusion networks and the word confusion network.

6. The distributed environment rescoring method of claim 5, wherein:
the list of the distributed queries is an n-gram list, and
the distributed query set is classified into the n-gram list.

7. A distributed environment rescoring apparatus, comprising:
a voice recognition unit configured to generate a word lattice by performing voice recognition on received voice;
a word confusion network generation unit configured to convert the word lattice into a word confusion network formed from temporal connection of confusion sets clustered based on temporal redundancy and phoneme similarities;
a subword confusion network list generation unit configured to generate a list of subword confusion networks based on entropy values of the respective confusion sets included in the word confusion network; and
a distributed environment rescoring unit configured to generate a modified word confusion network by modifying the list of the subword confusion networks through distributed environment rescoring.

8. The distributed environment rescoring apparatus of claim 7, wherein the word lattice is a graph that indicates a connection and directivity of word candidates recognized through the voice recognition.

9. The distributed environment rescoring apparatus of claim 7, wherein:
the confusion set comprises a list of words recognized through the voice recognition, and
each of the recognized words has a posterior probability value.

10. The distributed environment rescoring apparatus of claim 7, wherein the subword confusion network list generation unit calculates the entropy value based on posterior probability values of words included in the confusion set, selects the confusion set as a candidate of the subword confusion network based on the entropy value, and generates the list of the subword confusion networks based on context of the words included in the confusion set selected as the candidate of the subword confusion network.

11. The distributed environment rescoring apparatus of claim 10, wherein the distributed environment rescoring unit generates a list of distributed queries (openquery) to be transmitted to a plurality of distributed servers distributed over a network environment based on the list of the subword confusion networks, generates a distributed query set capable of being processed by the plurality of distributed servers based on the list of the distributed queries, transmits the distributed query set to the plurality of distributed servers, receives a score value for the distributed query set from each of the plurality of distributed servers, rescores the list of the subword confusion networks based on the score value for the distributed query set, and generates the modified word confusion network by integrating the list of the rescored subword confusion networks and the word confusion network.

12. The distributed environment rescoring apparatus of claim 11, wherein:
the list of the distributed queries is an n-gram list, and
the distributed query set is classified into the n-gram list.
